(19) United States
(12) Patent Application Publication
(10) Pub. No.: US 2024/0413713 A1
(43) Pub. Date: Dec. 12, 2024

(54) ELECTRIC WORK MACHINE

(71) Applicant: MAKITA CORPORATION, Anjo-shi (JP)

(72) Inventors: Naoto ICHIKAWA, Anjo-shi (JP); Yusuke HIRATA, Anjo-shi (JP); Hironori KANDORI, Anjo-shi (JP)

(73) Assignee: MAKITA CORPORATION, Anjo-shi (JP)

(21) Appl. No.: 18/609,552

(22) Filed: Mar. 19, 2024

(30) Foreign Application Priority Data
Jun. 7, 2023 (JP) 2023-094390

(51) Int. Cl. H02K 11/00; A01D 34/78; A01D 34/90; A01D 101/00; H02J 7/00; H02K 5/04; H02K 11/30

(52) U.S. Cl. CPC H02K 11/0094; H02J 7/0063; H02K 5/04; H02K 11/30; A01D 34/78; A01D 34/90; A01D 2101/00

(57) ABSTRACT

An electric work machine has less size increase. An electric work machine includes a power supply device, a first electric component, a second electric component, a first electric wire connecting the power supply device and the first electric component, a second electric wire connecting the power supply device and the second electric component, a power supply housing accommodating the power supply device, a first housing accommodating the first electric component, a second housing accommodating the second electric component, and a sheath accommodating the first electric wire and the second electric wire. The sheath has a first end located inside the power supply housing, and a second end located inside the first housing. The second electric wire extending from the sheath is placed in the second housing.

### CROSS-REFERENCE TO RELATED APPLICATIONS

This application claims the benefit of priority to Japanese Patent Application No. 2023-094390, filed on Jun. 7, 2023, the entire contents of which are hereby incorporated by reference.

### BACKGROUND

### 1. Technical Field

The disclosure relates to an electric work machine.

### 2. Description of the Background

An electric work machine described in Japanese Unexamined Patent Application Publication No. 2022-186580 includes electric components accommodated in different housings. The electric work machine thus uses a relay harness for connection between, for example, the power supply or a controller and the corresponding housing and uses a connection terminal for connection between the harnesses or between a harness and an electric component. The relay harness may be bent or located outside the housing and is to be protected against an external force. The harness is thus covered with a protective material such as a sheath. The protective material is also covered with a sheath cover such as a corrugated tube to prevent the protective material from being exposed outside.

### BRIEF SUMMARY

During the manufacturing processes of a relay harness, a sheath protecting the harness is difficult to peel off in the middle portion of the harness. When a sheathed harness is used, an appropriate amount of the harness is cut from a reel of sheathed harness. Unused portions of the sheath are then removed from the two ends of the cut harness to process the uncovered harness portions. To avoid such processing, the sheath is usually not removed in the middle portion of the sheathed harness. Each housing instead uses a relay harness or a connection terminal. However, the relay harnesses and the connection terminals increase the cost, or the connection terminals use space that increase the product size.

One or more aspects of the disclosure are directed to an electric work machine with less size increase.

A first aspect of the disclosure provides an electric work machine, including:
a power supply device;
a first electric component;
a second electric component;
a first electric wire connecting the power supply device and the first electric component;
a second electric wire connecting the power supply device and the second electric component;
a power supply housing accommodating the power supply device;
a first housing accommodating the first electric component without accommodating the second electric component;
a second housing accommodating the second electric component without accommodating the first electric component; and
a sheath accommodating the first electric wire and the second electric wire, the sheath having
   a first end located inside the power supply housing, and
   a second end located inside the first housing,
wherein the second electric wire extending from the sheath is placed in the second housing.

A second aspect of the disclosure provides an electric work machine, including:
a power supply device;
a first electric component;
a second electric component;
a first electric wire connecting the first electric component and the second electric component;
a second electric wire connecting the power supply device and the second electric component;
a power supply housing accommodating the power supply device;
a first housing accommodating the first electric component without accommodating the second electric component;
a second housing accommodating the second electric component without accommodating the first electric component; and
a sheath accommodating the first electric wire and the second electric wire, the sheath having
   a first end located inside the second housing, and
   a second end located inside the first housing,
wherein the second electric wire extending from the sheath is placed in the power supply housing.

The electric work machine according to the above aspects of the disclosure has less size increase.

### BRIEF DESCRIPTION OF DRAWINGS

FIG. 1 is a schematic diagram of an electric work machine according to a first embodiment.

FIG. 2 is a cross-sectional view of a sheath in the first embodiment.

FIG. 3 is a schematic diagram of an electric work machine according to a second embodiment.

FIG. 4 is a schematic diagram of an electric work machine according to a third embodiment.

FIG. 5 is a schematic diagram of an electric work machine according to a fourth embodiment.

FIG. 6 is a schematic diagram of an electric work machine according to a fifth embodiment.

FIG. 7 is a side view of an electric work machine according to a sixth embodiment.

FIG. 8 is a schematic diagram of the electric work machine according to the sixth embodiment.

FIG. 9 is a partial diagram of the electric work machine according to the sixth embodiment.

FIG. 10 is a partial diagram of the electric work machine according to the sixth embodiment.

FIG. 11 is a partial diagram of the electric work machine according to the sixth embodiment.

FIG. 12 is a diagram of an example connector in the sixth embodiment.

FIG. 13 is a diagram of an example connector in the sixth embodiment.

FIG. 14 is a diagram of an example connector in the sixth embodiment.

FIG. 15 is a side view of an electric work machine according to a seventh embodiment.

FIG. 16 is a schematic diagram of the electric work machine according to the seventh embodiment.

FIG. 17 is a side view of an electric work machine according to an eighth embodiment.

FIG. 18 is a schematic diagram of the electric work machine according to the eighth embodiment.

FIG. 19 is a side view of an electric work machine according to a ninth embodiment.

FIG. 20 is a schematic diagram of the electric work machine according to the ninth embodiment.

FIG. 21 is a side view of an electric work machine according to a tenth embodiment.

FIG. 22 is a schematic diagram of the electric work machine according to the tenth embodiment.

### DETAILED DESCRIPTION

One or more embodiments will now be described with reference to the drawings. In the embodiments, the positional relationships between the components will be described using the directional terms such as right and left (or lateral), front and rear (or frontward and rearward), and up and down (or vertical). The terms indicate relative positions or directions with respect to the center of an electric work machine.

### First Embodiment

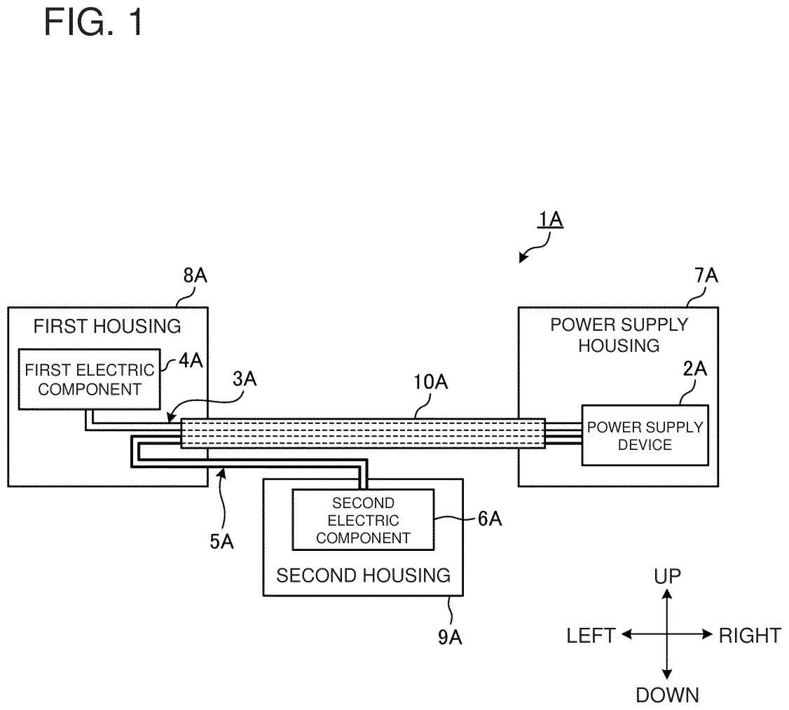

FIG. 1 is a schematic diagram of an electric work machine 1A according to the present embodiment. As shown in FIG. 1, the electric work machine 1A includes a power supply device 2A, a first electric component 4A, a second electric component 6A, a power supply housing 7A, a first housing 8A, a second housing 9A, and a sheath 10A. The first electric component 4A is connected to the power supply device 2A with first electric wires 3A. The second electric component 6A is connected to the power supply device 2A with second electric wires 5A.

The power supply housing 7A accommodates the power supply device 2A. The first housing 8A accommodates the first electric component 4A without accommodating the second electric component 6A. The second housing 9A accommodates the second electric component 6A without accommodating the first electric component 4A. The sheath 10A accommodates the first electric wires 3A and the second electric wires 5A. The sheath 10A has its right end located inside the power supply housing 7A. The sheath 10A has its left end located inside the first housing 8A. The second electric wires 5A extending from the left end of the sheath 10A are placed in the second housing 9A.

The power supply device 2A and the first electric component 4A are arranged in the lateral direction. The second electric component 6A is located between the power supply device 2A and the first electric component 4A in the lateral direction.

The second electric wires 5A extending leftward from the left end of the sheath 10A are folded rightward and placed in the second housing 9A.

The sheath 10A does not extend through the second housing 9A.

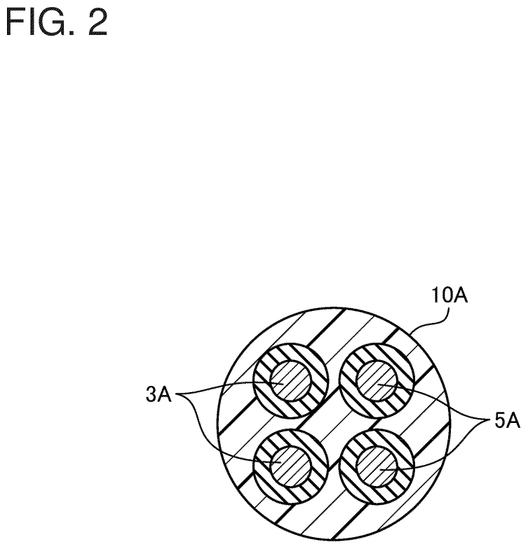

FIG. 2 is a cross-sectional view of the sheath 10A in the present embodiment. The sheath 10A accommodates multiple first electric wires 3A and multiple second electric wires 5A. More specifically, the sheath 10A in the present embodiment accommodates two first electric wires 3A and two second electric wires 5A. The sheath 10A is an electrical insulating member. The sheath 10A may be formed from, for example, rubber. The sheath 10A is substantially cylindrical.

As described above, the electric work machine 1A according to the present embodiment may include the power supply device 2A, the first electric component 4A, the second electric component 6A, the first electric wires 3A connecting the power supply device 2A and the first electric component 4A, the second electric wires 5A connecting the power supply device 2A and the second electric component 6A, the power supply housing 7A accommodating the power supply device 2A, the first housing 8A accommodating the first electric component 4A without accommodating the second electric component 6A, the second housing 9A accommodating the second electric component 6A without accommodating the first electric component 4A, and the sheath 10A accommodating the first electric wires 3A and the second electric wires 5A. The sheath 10A may have its right end (first end) located inside the power supply housing 7A, and its left end (second end) located inside the first housing 8A. The second electric wires 5A extending from the sheath 10A may be placed in the second housing 9A.

In the above structure, a single sheath 10A is used to supply power to each of the first electric component 4A and the second electric component 6A. The electric work machine 1A thus has less size increase.

In the present embodiment, the power supply device 2A and the first electric component 4A may be arranged in the lateral direction. The second electric component 6A may be located between the power supply device 2A and the first electric component 4A in the lateral direction.

The electric work machine 1A thus has less size increase.

In the present embodiment, the second electric wires 5A extending from the sheath 10A may be folded and placed in the second housing 9A.

The electric work machine 1A thus has less size increase.

The sheath 10A in the present embodiment may not extend through the second housing 9A.

The electric work machine 1A thus has less size increase.

### Second Embodiment

A second embodiment will be described. Like or corresponding components as those in the above embodiment will be described briefly or will not be described.

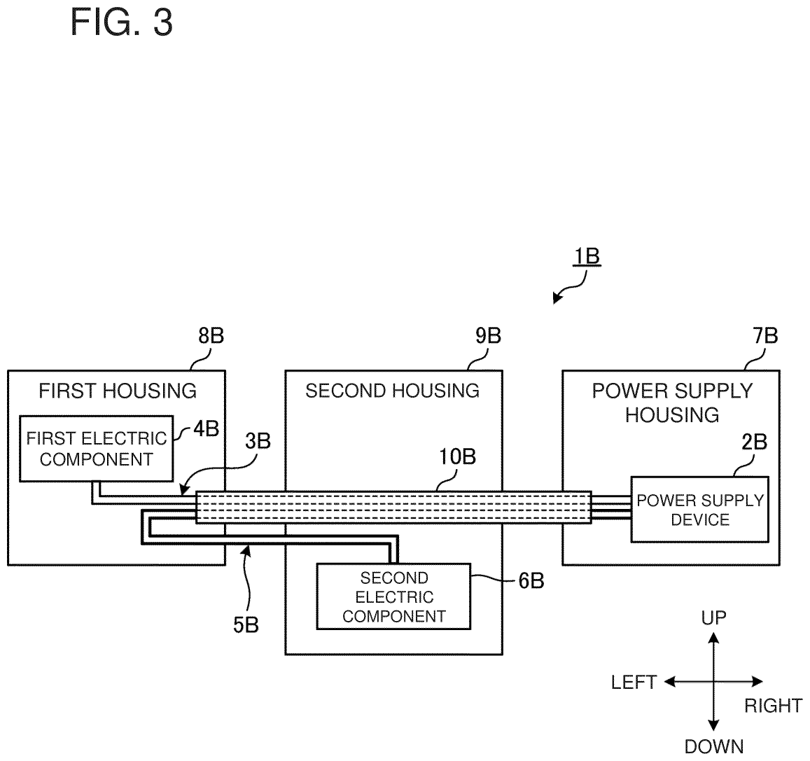

FIG. 3 is a schematic diagram of an electric work machine 1B according to the present embodiment. As shown in FIG. 3, the electric work machine 1B includes a power supply device 2B, a first electric component 4B, a second electric component 6B, a power supply housing 7B, a first housing 8B, a second housing 9B, and a sheath 10B. The first electric component 4B is connected to the power supply device 2B with first electric wires 3B. The second electric component 6B is connected to the power supply device 2B with second electric wires 5B.

The power supply housing 7B accommodates the power supply device 2B. The first housing 8B accommodates the first electric component 4B without accommodating the second electric component 6B. The second housing 9B accommodates the second electric component 6B without accommodating the first electric component 4B. The sheath 10B accommodates the first electric wires 3B and the second electric wires 5B. The sheath 10B has its right end located inside the power supply housing 7B. The sheath 10B has its left end located inside the first housing 8B. The second electric wires 5B extending from the left end of the sheath 10B are placed in the second housing 9B.

The power supply device 2B and the first electric component 4B are arranged in the lateral direction. The second electric component 6B is located between the power supply device 2B and the first electric component 4B in the lateral direction.

The second electric wires 5B extending leftward from the left end of the sheath 10B are folded rightward and placed in the second housing 9B.

The sheath 10B extends through the second housing 9B.

As described above, the sheath 10B in the present embodiment may extend through the second housing 9B.

The second housing 9B thus supports the sheath 10B.

### Third Embodiment

A third embodiment will be described. Like or corresponding components as those in the above embodiments will be described briefly or will not be described.

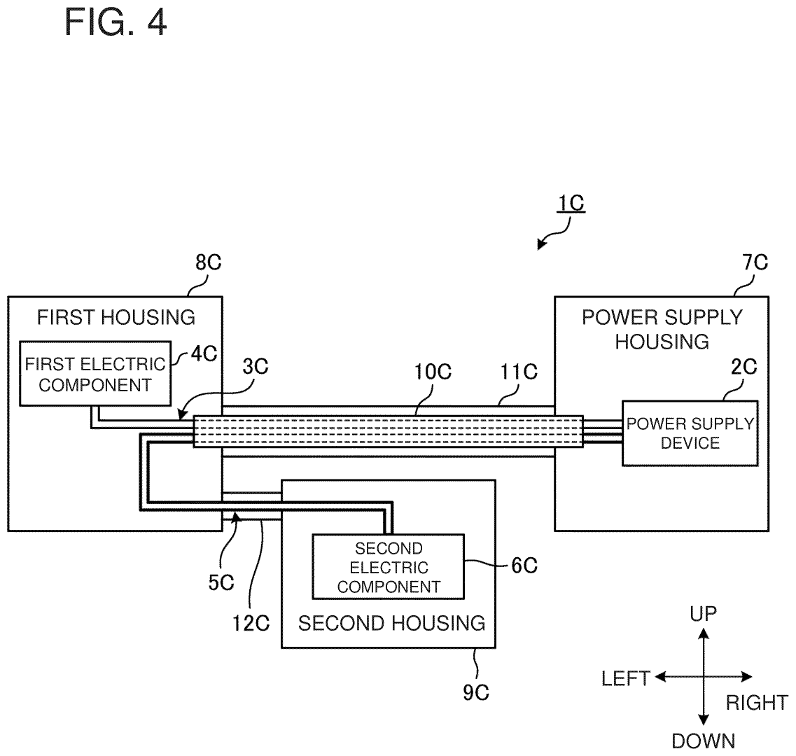

FIG. 4 is a schematic diagram of an electric work machine 1C according to the present embodiment. As shown in FIG. 4, the electric work machine 1C includes a power supply device 2C, a first electric component 4C, a second electric component 6C, a power supply housing 7C, a first housing 8C, a second housing 9C, and a sheath 10C. The first electric component 4C is connected to the power supply device 2C with first electric wires 3C. The second electric component 6C is connected to the power supply device 2C with second electric wires 5C.

The power supply housing 7C accommodates the power supply device 2C. The first housing 8C accommodates the first electric component 4C without accommodating the second electric component 6C. The second housing 9C accommodates the second electric component 6C without accommodating the first electric component 4C. The sheath 10C accommodates the first electric wires 3C and the second electric wires 5C. The sheath 10C has its right end located inside the power supply housing 7C. The sheath 10C has its left end located inside the first housing 8C. The second electric wires 5C extending from the left end of the sheath 10C are placed in the second housing 9C.

The power supply device 2C and the first electric component 4C are arranged in the lateral direction. The second electric component 6C is located between the power supply device 2C and the first electric component 4C in the lateral direction.

The second electric wires 5C extending leftward from the left end of the sheath 10C are folded rightward and placed in the second housing 9C.

The sheath 10C does not extend through the second housing 9C.

The electric work machine 1C according to the present embodiment includes a first connecting member 11C connecting the power supply housing 7C and the first housing 8C. The first connecting member 11C is, for example, a pipe or a rod. The first connecting member 11C supports the sheath 10C.

The electric work machine 1C according to the present embodiment includes a second connecting member 12C connecting the first housing 8C and the second housing 9C. The second connecting member 12C is, for example, a pipe or a rod. The second connecting member 12C supports the second electric wires 5C extending from the sheath 10C.

As described above, the electric work machine 1C according to the present embodiment may include the first connecting member 11C connecting the power supply housing 7C and the first housing 8C.

The first connecting member 11C may support the sheath 10C.

The electric work machine 1C according to the present embodiment may include the second connecting member 12C connecting the first housing 8C and the second housing 9C.

The second connecting member 12C may support the second electric wires 5C extending from the sheath 10C.

### Fourth Embodiment

A fourth embodiment will be described. Like or corresponding components as those in the above embodiments will be described briefly or will not be described.

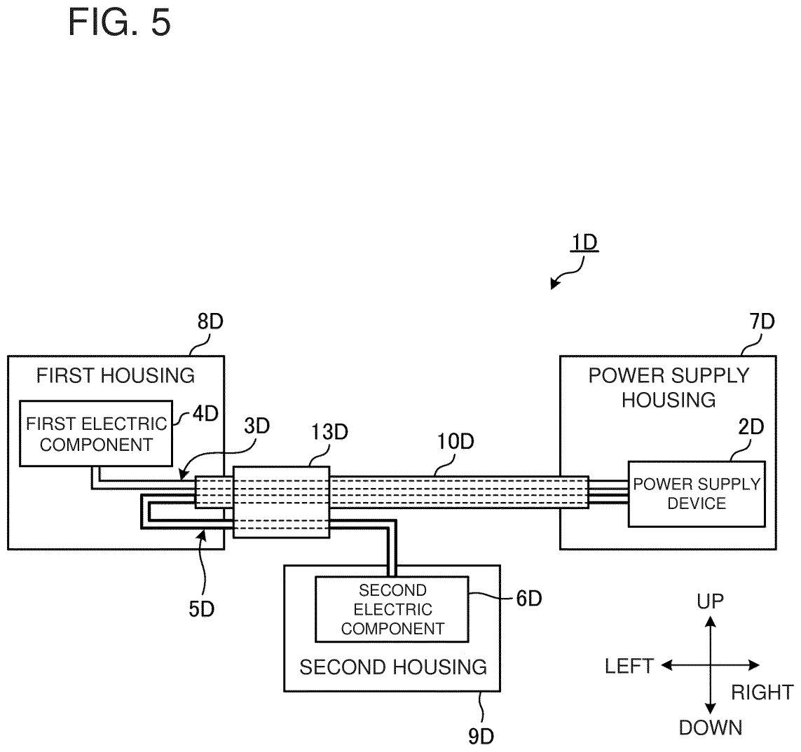

FIG. 5 is a schematic diagram of an electric work machine 1D according to the present embodiment. As shown in FIG. 5, the electric work machine 1D includes a power supply device 2D, a first electric component 4D, a second electric component 6D, a power supply housing 7D, a first housing 8D, a second housing 9D, and a sheath 10D. The first electric component 4D is connected to the power supply device 2D with first electric wires 3D. The second electric component 6D is connected to the power supply device 2D with second electric wires 5D.

The power supply housing 7D accommodates the power supply device 2D. The first housing 8D accommodates the first electric component 4D without accommodating the second electric component 6D. The second housing 9D accommodates the second electric component 6D without accommodating the first electric component 4D. The sheath 10D accommodates the first electric wires 3D and the second electric wires 5D. The sheath 10D has its right end located inside the power supply housing 7D. The sheath 10D has its left end located inside the first housing 8D. The second electric wires 5D extending from the left end of the sheath 10D are placed in the second housing 9D.

The power supply device 2D and the first electric component 4D are arranged in the lateral direction. The second electric component 6D is located between the power supply device 2D and the first electric component 4D in the lateral direction.

The second electric wires 5D extending leftward from the left end of the sheath 10D are folded rightward and placed in the second housing 9D.

The sheath 10D does not extend through the second housing 9D.

The electric work machine 1D according to the present embodiment includes a sheath cover 13D. The sheath cover 13D accommodates the sheath 10D and the second electric wires 5D extending outside the sheath 10D. The second electric wires 5D extending leftward from the left end of the sheath 10D and folded rightward are located adjacent to the outer surface of the sheath 10D. The sheath cover 13D accommodates the sheath 10D and the second electric wires 5D located adjacent to the outer surface of the sheath 10D. The sheath cover 13D is tubular. The sheath cover 13D in the present embodiment is a corrugated tube. The sheath cover 13D bundles the sheath 10D and the second electric wires 5D extending outside the sheath 10D.

As described above, the electric work machine 1D according to the present embodiment may include the sheath cover 13D accommodating the sheath 10D and the second electric wires 5D extending outside the sheath 10D.

The sheath cover 13D bundles the sheath 10D and the second electric wires 5D.

### Fifth Embodiment

A fifth embodiment will be described. Like or corresponding components as those in the above embodiments will be described briefly or will not be described.

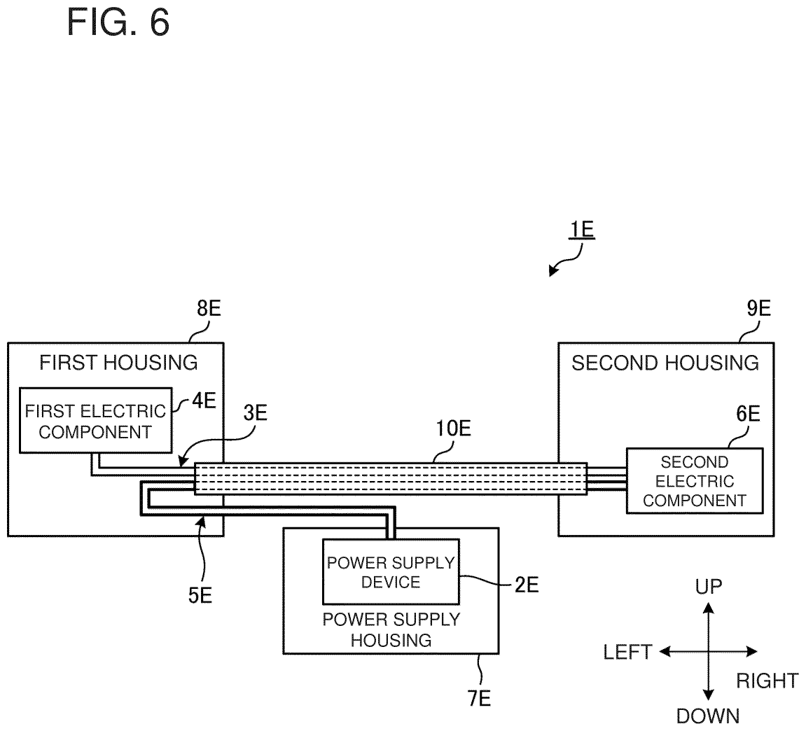

FIG. 6 is a schematic diagram of an electric work machine 1E according to the present embodiment. As shown in FIG. 6, the electric work machine 1E includes a power supply device 2E, a second electric component 6E, a first electric component 4E, a power supply housing 7E, a first housing 8E, a second housing 9E, and a sheath 10E. The second electric component 6E is connected to the power supply device 2E with second electric wires 5E. The first electric component 4E is connected to the second electric component 6E with first electric wires 3E.

The power supply housing 7E accommodates the power supply device 2E. The first housing 8E accommodates the first electric component 4E without accommodating the second electric component 6E. The second housing 9E accommodates the second electric component 6E without accommodating the first electric component 4E. The sheath 10E accommodates the first electric wires 3E and the second electric wires 5E. The sheath 10E has its right end located inside the second housing 9E. The sheath 10E has its left end located inside the first housing 8E. The second electric wires 5E extending from the left end of the sheath 10E are placed in the power supply housing 7E.

The first electric component 4E and the second electric component 6E are arranged in the lateral direction. The power supply device 2E is located between the first electric component 4E and the second electric component 6E in the lateral direction.

The second electric wires 5E extending leftward from the left end of the sheath 10E are folded rightward and placed in the power supply housing 7E.

The sheath 10E does not extend through the power supply housing 7E.

As described above, the electric work machine 1E according to the present embodiment may include the power supply device 2E, the first electric component 4E, the second electric component 6E, the first electric wires 3E connecting the first electric component 4E and the second electric component 6E, the second electric wires 5E connecting the power supply device 2E and the second electric component 6E, the power supply housing 7E accommodating the power supply device 2E, the first housing 8E accommodating the first electric component 4E without accommodating the second electric component 6E, the second housing 9E accommodating the second electric component 6E without accommodating the first electric component 4E, and the sheath 10E accommodating the first electric wires 3E and the second electric wires 5E. The sheath 10E may have its right end (first end) located inside the second housing 9E, and its left end (second end) located inside the first housing 8E. The second electric wires 5E extending from the sheath 10E may be placed in the power supply housing 7E.

In the above structure, a single sheath 10E is used to supply power to the first electric component 4E and the second electric component 6E. The electric work machine 1E thus has less size increase.

In the present embodiment, the first electric component 4E and the second electric component 6E are arranged in the lateral direction. The power supply device 2E may be located between the first electric component 4E and the second electric component 6E in the lateral direction.

The electric work machine 1E thus has less size increase.

In one or more embodiments, the second electric wires 5E extending from the sheath 10E may be folded and placed in the power supply housing 7E.

The electric work machine 1E thus has less size increase.

### First Electric Component and Second Electric Component

In the first to fifth embodiments described above, the first electric component and the second electric component are, for example, actuators (motors or solenoids), light-emitting diodes or LEDs (including chip-on-board LEDs), sensors (temperature sensors or acceleration sensors), displays (organic electroluminescent or EL displays, electronic papers, or liquid crystal displays), switches, controllers, field-effect transistors (FETs), or external connectors (universal serial bus or USB terminals or wireless unit connection terminals).

### Sixth Embodiment

A sixth embodiment will be described. Like or corresponding components as those in the above embodiments will be described briefly or will not be described.

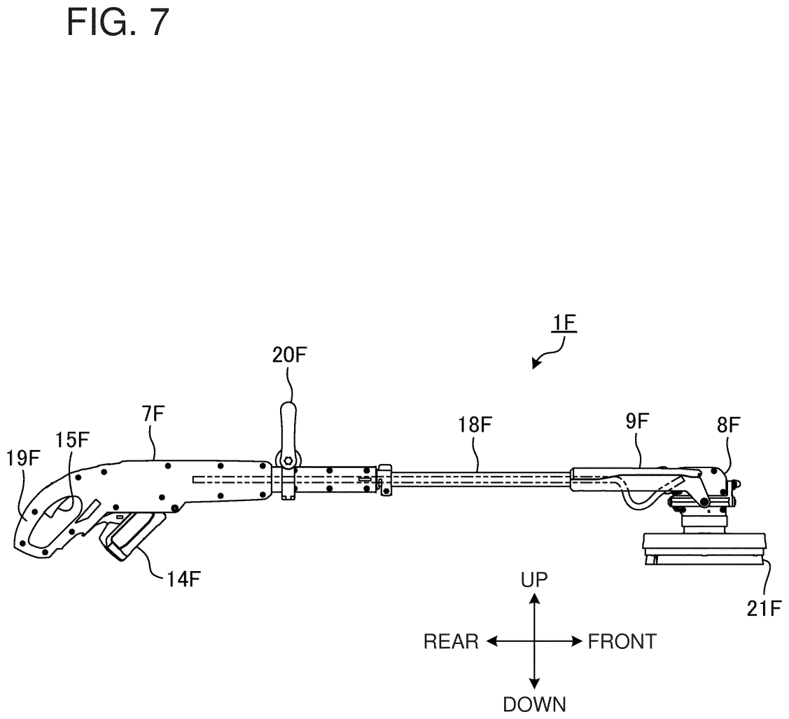

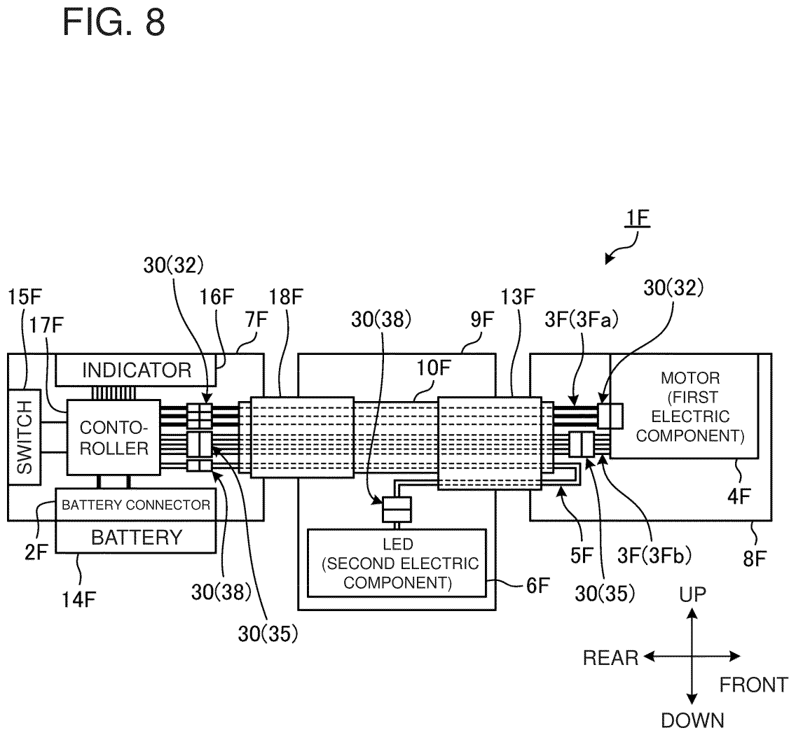

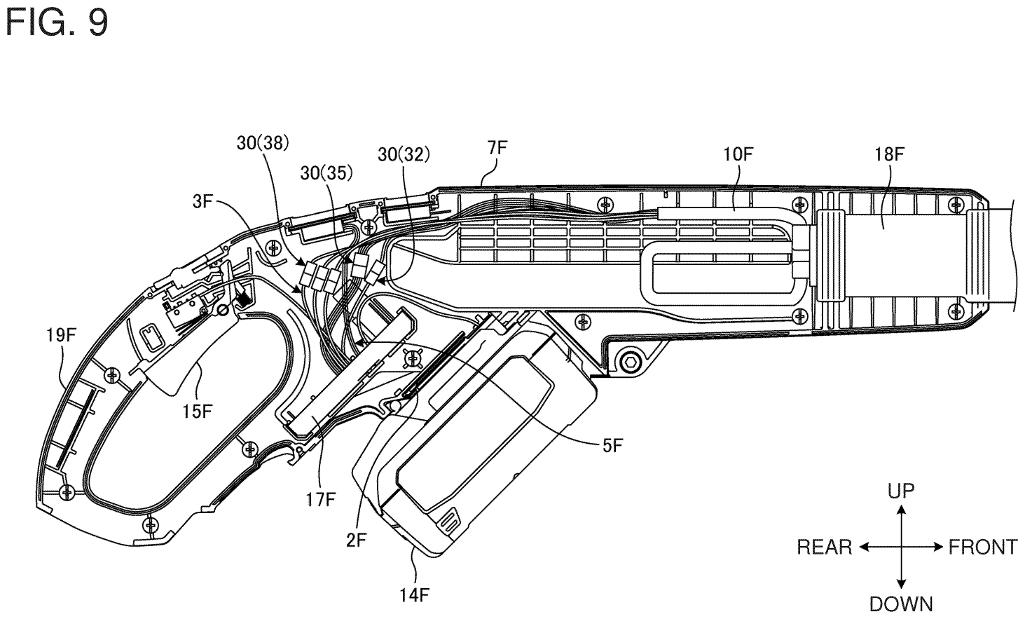

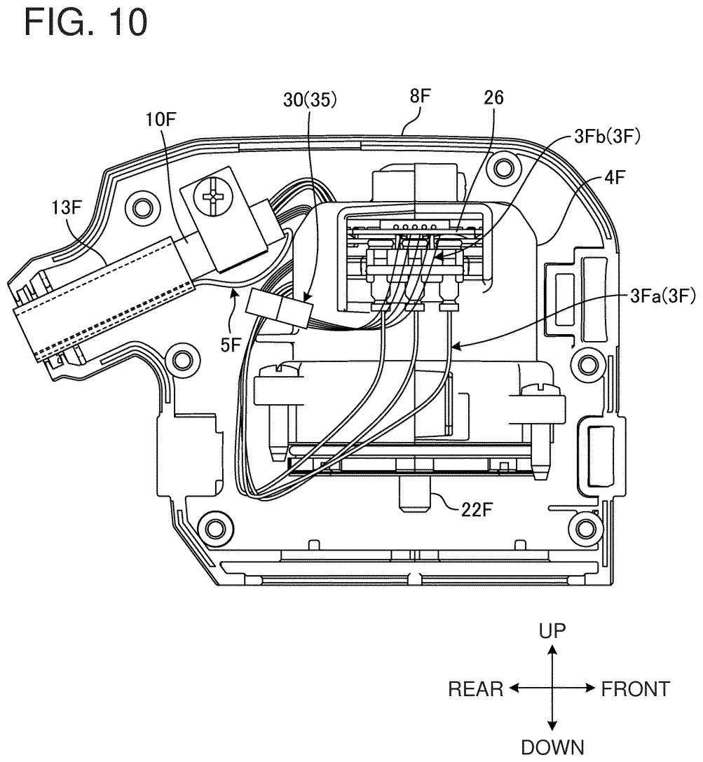

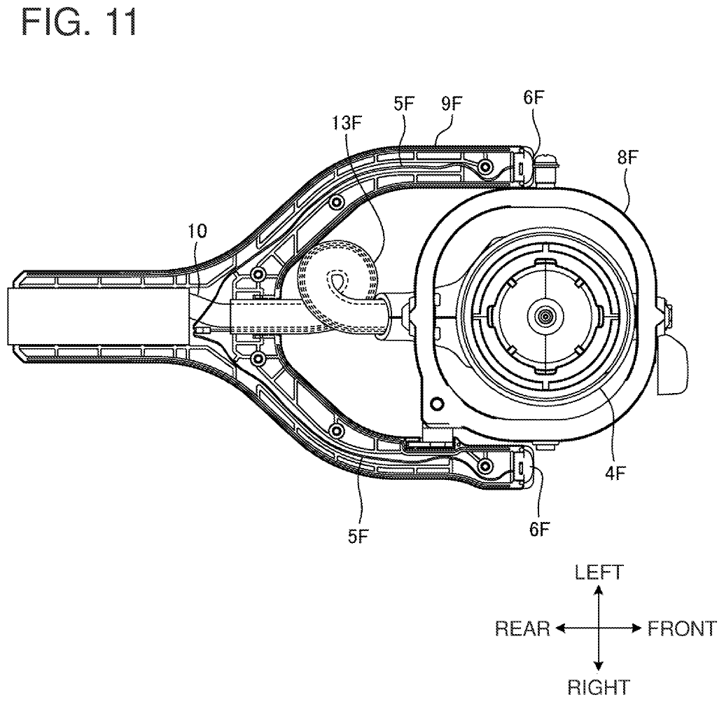

FIG. 7 is a side view of an electric work machine 1F according to the present embodiment. FIG. 8 is a schematic diagram of the electric work machine 1F. FIG. 9 is a partial diagram of the electric work machine 1F. FIG. 10 is a partial diagram of the electric work machine 1F. FIG. 11 is a partial diagram of the electric work machine 1F. The electric work machine 1F according to the present embodiment is a scrubber.

The electric work machine 1F includes a battery connector 2F, a controller 17F, a switch 15F, an indicator 16F, a motor 4F, lights (LEDs) 6F, a power supply housing 7F, a first housing 8F, a second housing 9F, and a sheath 10F. A battery 14F is connected to the battery connector 2F. The controller 17F is connected to the battery connector 2F. The switch 15F is connected to the controller 17F. The indicator 16F is connected to the controller 17F. The motor 4F is connected to the battery connector 2F with first electric wires 3F through the controller 17F. The lights 6F are connected to the battery connector 2F with second electric wires 5F through the controller 17F. The power supply housing 7F accommodates the battery connector 2F, the controller 17F, the switch 15F, and the indicator 16F. The first housing 8F accommodates the motor 4F without accommodating the lights 6F. The second housing 9F accommodates the lights 6F without accommodating the motor 4F. The sheath 10F accommodates the first electric wires 3F and the second electric wires 5F. The sheath 10F has its rear end located inside the power supply housing 7F. The sheath 10F has its front end located inside the first housing 8F. The second electric wires 5F extending from the front end of the sheath 10F are placed in the second housing 9F.

The electric work machine 1F according to the present embodiment includes a pipe 18F and a sheath cover 13F. The pipe 18F connects the power supply housing 7F and the second housing 9F. The sheath cover 13F accommodates the sheath 10F and the second electric wires 5F extending outside the sheath 10F. The sheath 10F is received in the pipe 18F.

As shown in FIG. 7, a grip 19F is located in a rear portion of the power supply housing 7F. The switch 15F is located on the grip 19F. A grip 20F is located frontward from the power supply housing 7F. The electric work machine 1F further includes a cleaning member 21F rotatable by the motor 4F. The motor 4F is an inner-rotor direct current (DC) brushless motor. As shown in FIG. 10, the motor 4F has a rotor shaft 22F protruding downward from the motor 4F. The cleaning member 21F is connected to the rotor shaft 22F. As shown in FIG. 11, the second housing 9F accommodates the lights 6F. The lights 6F are arranged to emit light from the left and the right of the first housing 8F.

A small scrubber is often used in a small and narrow area with obstacles blocking light toward the surface to be cleaned. The lights 6F thus increase the work efficiency. The scrubber includes a distal end shock absorber, allowing the head of the scrubber to freely change the angle when cleaning under, for example, a chair, a desk, or a shelf to improve the operability. In cleaning a dark area, the floor surface on the right and left ahead of the head is to be illuminated with light. In the present embodiment, the lights 6F are arranged on each of the right and left distal ends of a Y-shaped arm (yoke) connecting the rod and the head. The lights 6F are arranged at positions and angles to efficiently illuminate a front half of the floor surface ahead of the head as viewed from the operator, within the arm angle of the operation area (0° in the horizontal direction to about 60° in the vertical direction).

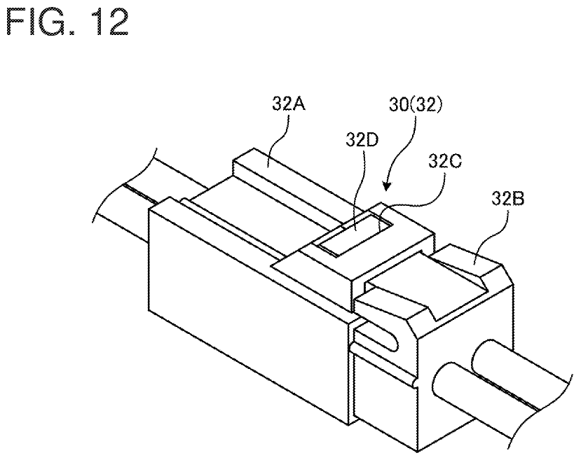

FIGS. 12 to 14 each show an example connector 30 in the present embodiment.

FIG. 12 shows a connector 32 with two pins. The connector 32 includes a housing 32A and a housing 32B. The housing 32A holds the pins. The housing 32B has holes to receive the pins. The housing 32B includes a tab 32D. The housing 32A includes an engagement portion 32C engageable with the tab 32D. The engagement portion 32C has an opening to receive the tab 32D. The housing 32A and the housing 32B are fastened together with an inner lock. This places the pins into the respective holes, connecting the electric wires connected to the pins and the electric wires connected to the holes together.

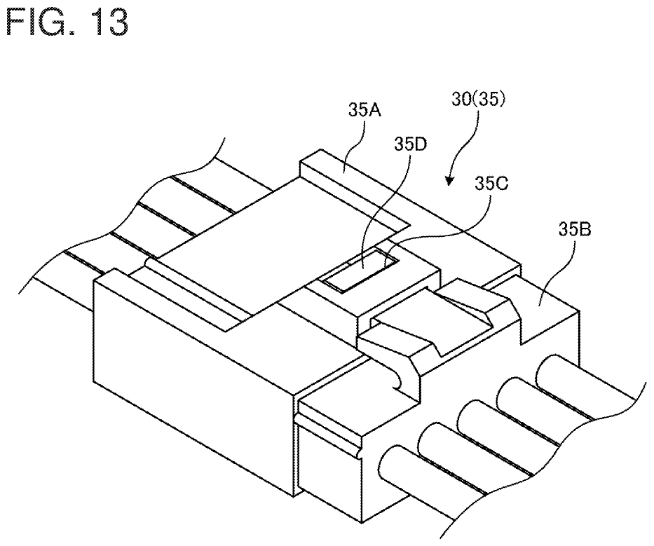

FIG. 13 shows a connector 35 with five pins. The connector 35 includes a housing 35A and a housing 35B. The housing 35A holds the pins. The housing 35B has holes to receive the pins. The housing 35B includes a tab 35D. The housing 35A includes an engagement portion 35C engageable with the tab 35D. The engagement portion 35C has an opening to receive the tab 35D. The housing 35A and the housing 35B are fastened together with an inner lock. This places the pins into the respective holes, connecting the electric wires connected to the pins and the electric wires connected to the holes together.

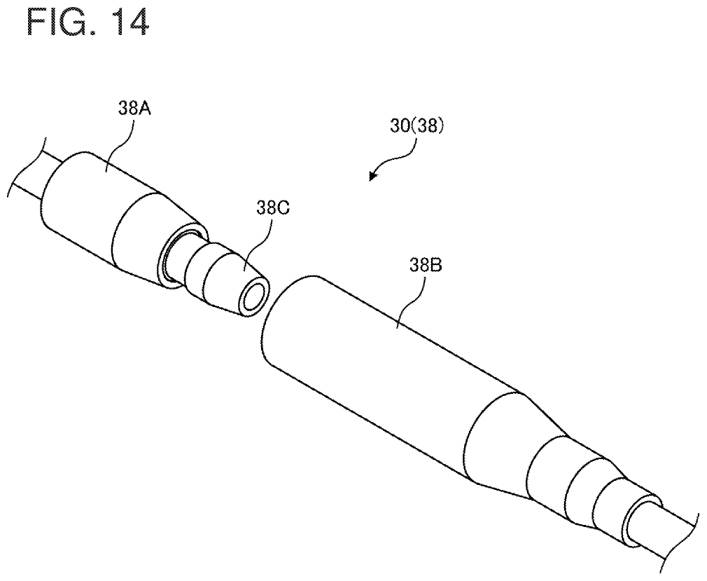

FIG. 14 shows a connector 38 called a bullet terminal. The connector 38 includes a housing 38A and a housing 38B. The housing 38A holds a male terminal 38C. The housing 38B holds a female terminal into which the male terminal 38C is placed. The male terminal 38C is placed into the female terminal, connecting the electric wires connected to the male terminal 38C and the electric wires connected to the female terminal.

In the present embodiment, the battery connector 2F, to which the battery 14F is connected, corresponds to the power supply device. The battery 14F is attachable to and detachable from the battery connector 2F. The battery 14F supplies power to the battery connector 2F. The motor 4F corresponds to the first electric component. The motor 4F drives the electric work machine 1F. The lights 6F correspond to the second electric component. The lights 6F illuminate a target area of the electric work machine 1F with illumination light. The switch 15F is operable by the operator to activate the motor 4F. The controller 17F controls at least the motor 4F.

The electric work machine 1F includes multiple first electric wires 3F. At least one of the first electric wires 3F is a power line 3Fa. The battery 14F supplies a drive current to the motor 4F through the power line 3Fa. At least one of the first electric wires 3F is a signal line 3Fb. The signal line 3Fb transmits, to the controller 17F, a detection signal from a rotation sensor mounted on a sensor board 26 in the motor 4F. As shown in FIG. 10, the electric work machine 1F includes three power lines 3Fa and five signal lines 3Fb.

The electric work machine 1F may include multiple second electric wires 5F. At least one of the second electric wires 5F is a power line. A battery 14G supplies a drive current to the lights 6F through the power line.

Multiple connectors 32 are used to connect the power lines 3Fa. Multiple connectors 35 are used to connect the signal lines 3Fb. Multiple connectors 35 are used to connect the second electric wires 5F.

### Seventh Embodiment

A seventh embodiment will be described. Like or corresponding components as those in the above embodiments will be described briefly or will not be described.

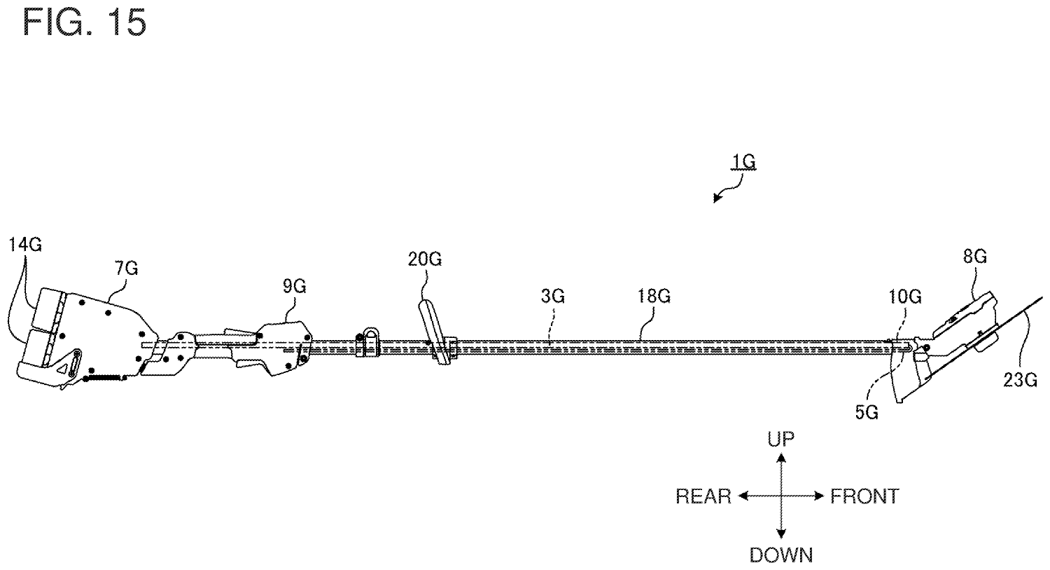

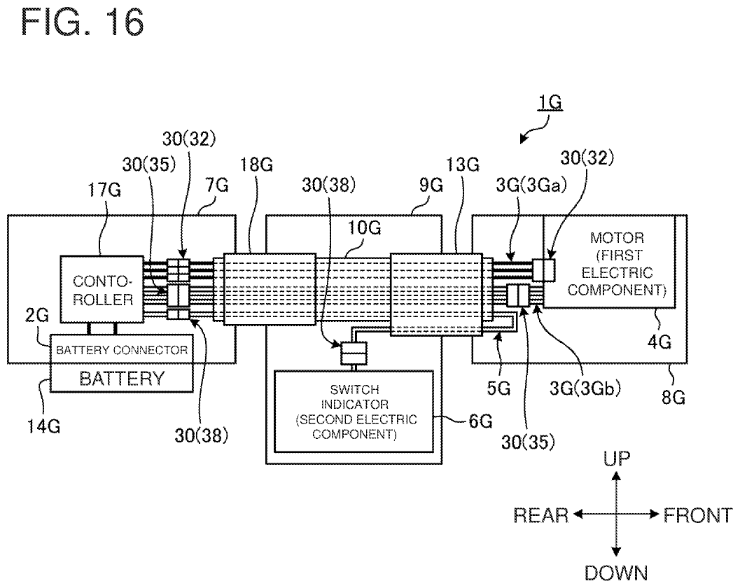

FIG. 15 is a side view of an electric work machine 1G according to the present embodiment. FIG. 16 is a schematic diagram of the electric work machine 1G. The electric work machine 1G according to the present embodiment is a mowing machine.

The electric work machine 1G includes a battery connector 2G, a controller 17G, a motor 4G, a switch and an indicator 6G, a power supply housing 7G, a first housing 8G, a second housing 9G, and a sheath 10G. The battery 14G is connected to the battery connector 2G. The controller 17G is connected to the battery connector 2G. The motor 4G is connected to the battery connector 2G with first electric wires 3G through the controller 17G. The switch and the indicator 6G are connected to the battery connector 2G with second electric wires 5G through the controller 17G. The power supply housing 7G accommodates the battery connector 2G and the controller 17G. The first housing 8G accommodates the motor 4G without accommodating the switch and the indicator 6G. The second housing 9G accommodates the switch and the indicator 6G without accommodating the motor 4G. The sheath 10G accommodates the first electric wires 3G and the second electric wires 5G. The sheath 10G has its rear end located inside the power supply housing 7G. The sheath 10G has its front end located inside the first housing 8G. The second electric wires 5G extending from the front end of the sheath 10G are placed in the second housing 9G.

The electric work machine 1G according to the present embodiment includes a pipe 18G and a sheath cover 13G. The pipe 18G connects the power supply housing 7G, the second housing 9G, and the first housing 8G. The sheath cover 13G accommodates the sheath 10G and the second electric wires 5G extending outside the sheath 10G. The pipe 18G supports the sheath 10G.

As shown in FIG. 15, a grip 20G is located frontward from the second housing 9G. The electric work machine 1G further includes a grass cutting blade 23G rotatable by the motor 4G.

In the present embodiment, the battery connector 2G, to which the battery 14G is connected, corresponds to the power supply device. The battery 14G is attachable to and detachable from the battery connector 2G. The motor 4G corresponds to the first electric component. The motor 4G drives the electric work machine 1G. The switch and the indicator 6G correspond to the second electric component. The switch is operable by the operator to activate the motor 4G. The controller 17G controls at least the motor 4G.

The electric work machine 1G includes multiple first electric wires 3G. At least one of the first electric wires 3G is a power line 3Ga. The battery 14G supplies a drive current to the motor 4G through the power line 3Ga. At least one of the first electric wires 3G is a signal line 3Gb. The signal line 3Gb transmits, to the controller 17G, a detection signal from a rotation sensor in the motor 4G.

The electric work machine 1G may include multiple second electric wires 5G. At least one of the second electric wires 5G is a signal line. An electric signal is transmitted through the signal line from the switch operated to activate the motor 4G to the controller 17G that controls the motor 4G.

### Eighth Embodiment

An eighth embodiment will be described. Like or corresponding components as those in the above embodiments will be described briefly or will not be described.

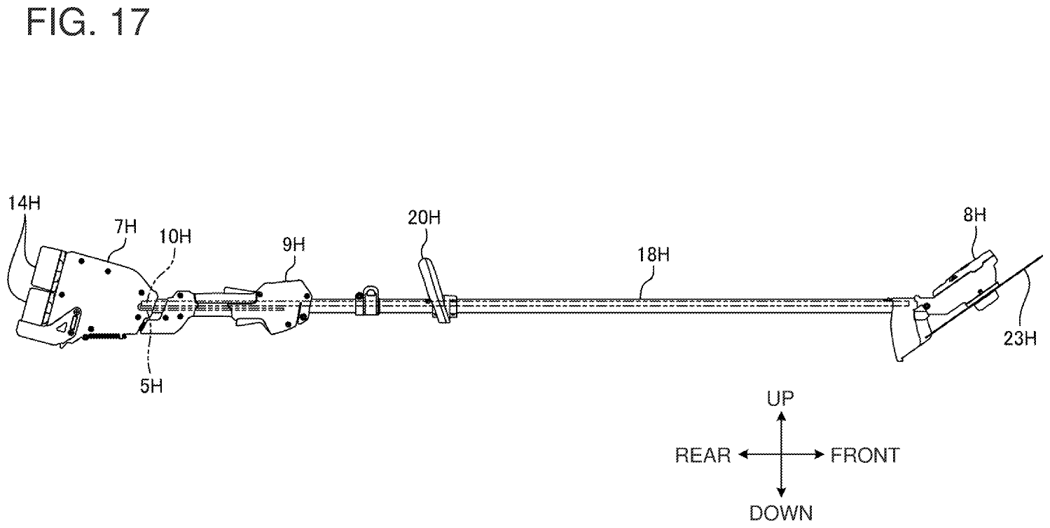

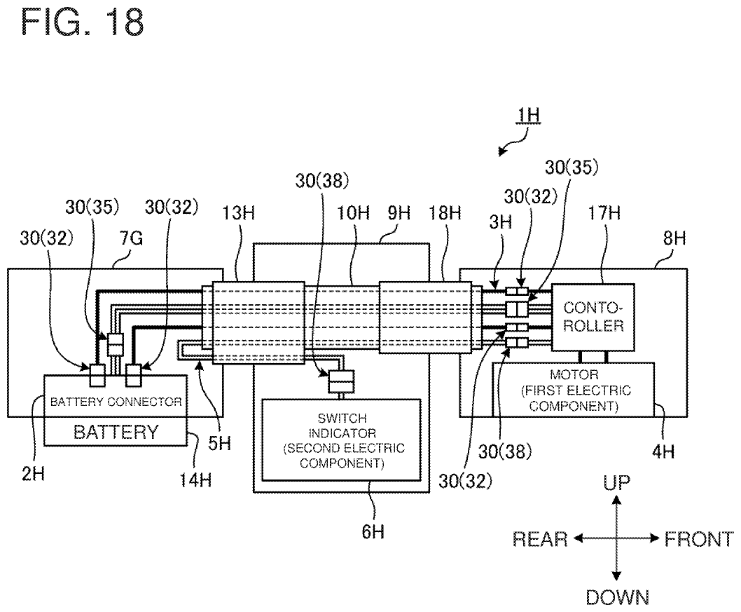

FIG. 17 is a side view of an electric work machine 1H according to the present embodiment. FIG. 18 is a schematic diagram of the electric work machine 1H. The electric work machine 1H according to the present embodiment is a mowing machine.

The electric work machine 1H includes a battery connector 2H, a controller 17H, a motor 4H, a switch and an indicator 6H, a power supply housing 7H, a first housing 8H, a second housing 9H, and a sheath 10H. A battery 14H is connected to the battery connector 2H. The motor 4H is connected to the controller 17H. The power supply housing 7H accommodates the battery connector 2H. The first housing 8H accommodates the motor 4H and the controller 17H without accommodating the switch and the indicator 6H. The second housing 9H accommodates the switch and the indicator 6H without accommodating the motor 4H and the controller 17H. The sheath 10H accommodates first electric wires 3H and second electric wires 5H. The battery connector 2H is connected to the controller 17H with the first electric wires 3H. The switch and the indicator 6H are connected to the controller 17H with the second electric wires 5H. The sheath 10H has its rear end located inside the power supply housing 7H. The sheath 10H has its front end located inside the first housing 8H. The second electric wires 5H extending from the rear end of the sheath 10H are placed in the second housing 9H.

The electric work machine 1H according to the present embodiment includes a pipe 18H and a sheath cover 13H. The pipe 18H connects the power supply housing 7H, the second housing 9H, and the first housing 8H. The sheath cover 13H accommodates the sheath 10H and the second electric wires 5H extending outside the sheath 10H. The pipe 18H supports the sheath 10H.

As shown in FIG. 17, a grip 20H is located frontward from the second housing 9H. The electric work machine 1H further includes a grass cutting blade 23H rotatable by the motor 4H.

In the present embodiment, the battery connector 2H, to which the battery 14H is connected, corresponds to the power supply device. The battery 14H is attachable to and detachable from the battery connector 2H. The motor 4H corresponds to the first electric component. The motor 4H drives the electric work machine 1H. The switch and the indicator 6H correspond to the second electric component. The switch is operable by the operator to activate the motor 4H. The controller 17H controls at least the motor 4H.

The electric work machine 1H includes multiple first electric wires 3H. At least one of the first electric wires 3H is a power line. The battery 14H supplies a drive current to the motor 4H through the power line. At least one of the first electric wires 3H is a signal line. The signal line transmits, to the controller 17H, a detection signal from a rotation sensor in the motor 4H.

The electric work machine 1H may include multiple second electric wires 5H. At least one of the second electric wires 5H is a signal line. An electric signal is transmitted through the signal line from the switch operated to activate the motor 4H to the controller 17H that controls the motor 4H.

### Ninth Embodiment

A ninth embodiment will be described. Like or corresponding components as those in the above embodiments will be described briefly or will not be described.

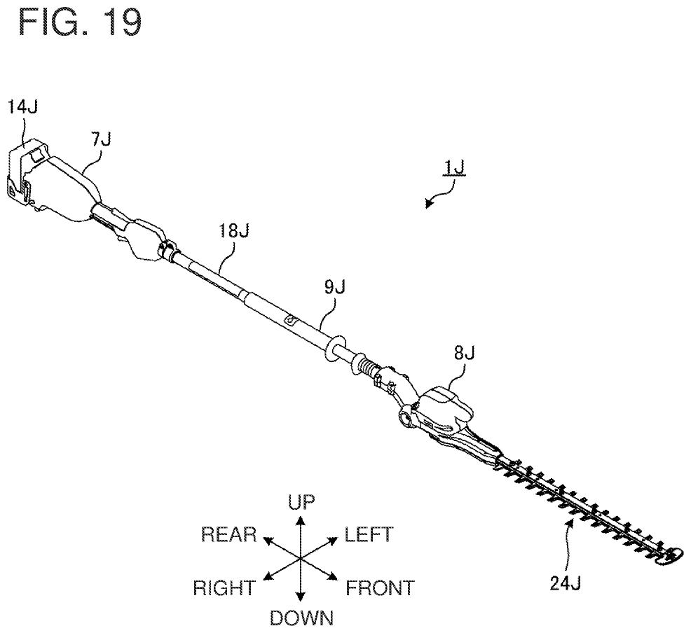

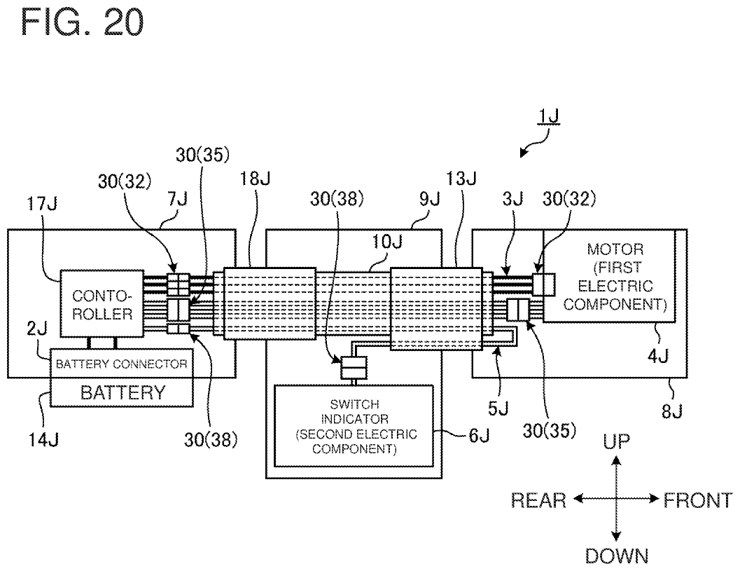

FIG. 19 is a side view of an electric work machine 1J according to the present embodiment. FIG. 20 is a schematic diagram of the electric work machine 1J. The electric work machine 1J according to the present embodiment is a hedge trimmer.

The electric work machine 1J includes a battery connector 2J, a controller 17J, a motor 4J, a switch and an indicator 6J, a power supply housing 7J, a first housing 8J, a second housing 9J, and a sheath 10J. A battery 14J is connected to the battery connector 2J. The controller 17J is connected to the battery connector 2J. The motor 4J is connected to the battery connector 2J with first electric wires 3J through the controller 17J. The switch and the indicator 6J are connected to the battery connector 2J with second electric wires 5J through the controller 17J. The power supply housing 7J accommodates the battery connector 2J and the controller 17J. The first housing 8J accommodates the motor 4J without accommodating the switch and the indicator 6J. The second housing 9J accommodates the switch and the indicator 6J without accommodating the motor 4J. The sheath 10J accommodates the first electric wires 3J and the second electric wires 5J. The sheath 10J has its rear end located inside the power supply housing 7J. The sheath 10J has its front end located inside the first housing 8J. The second electric wires 5J extending from the front end of the sheath 10J are placed in the second housing 9J.

The electric work machine 1J according to the present embodiment includes a pipe 18J and a sheath cover 13J. The pipe 18J connects the power supply housing 7J and the second housing 9J. The sheath cover 13J accommodates the sheath 10J and the second electric wires 5J extending outside the sheath 10J. The pipe 18J supports the sheath 10J.

As shown in FIG. 19, the electric work machine 1J includes a blade 24J rotatable by the motor 4J.

In the present embodiment, the battery connector 2J, to which the battery 14J is connected, corresponds to the power supply device. The battery 14J is attachable to and detachable from the battery connector 2J. The motor 4J corresponds to the first electric component. The motor 4J drives the electric work machine 1J. The switch and the indicator 6J correspond to the second electric component. The switch is operable by the operator to activate the motor 4J. The controller 17J controls at least the motor 4J.

The electric work machine 1J includes multiple first electric wires 3J. At least one of the first electric wires 3J is a power line. The battery 14J supplies a drive current to the motor 4J through the power line. At least one of the first electric wires 3J is a signal line. The signal line transmits, to the controller 17J, a detection signal from a rotation sensor in the motor 4J.

The electric work machine 1J may include multiple second electric wires 5J. At least one of the second electric wires 5J is a signal line. An electric signal is transmitted through the signal line from the switch operated to activate the motor 4J to the controller 17J that controls the motor 4J.

### Tenth Embodiment

A tenth embodiment will be described. Like or corresponding components as those in the above embodiments will be described briefly or will not be described.

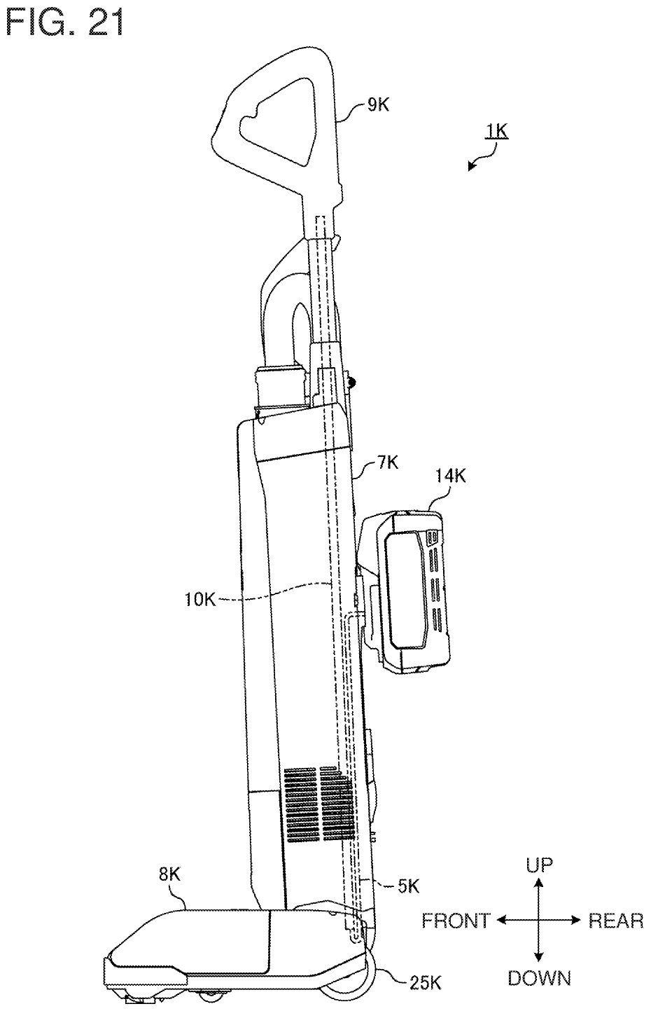

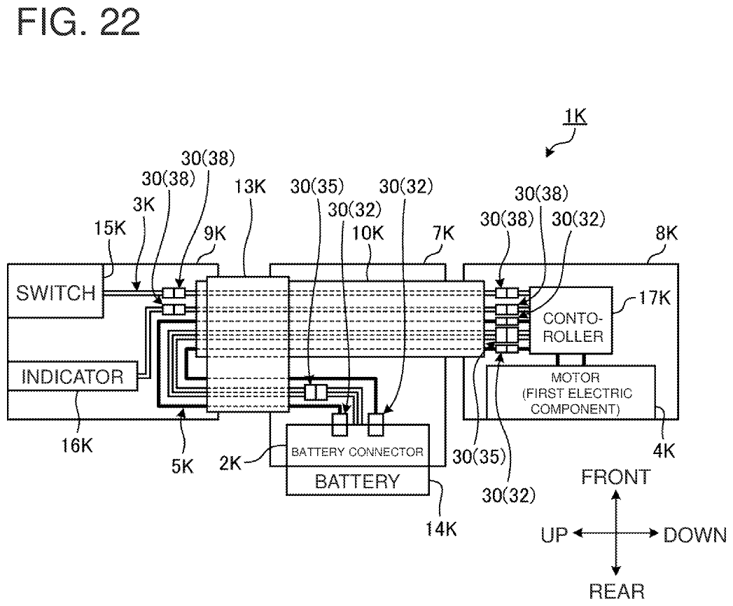

FIG. 21 is a side view of an electric work machine 1K according to the present embodiment. FIG. 22 is a schematic diagram of the electric work machine 1K. The electric work machine 1K according to the present embodiment is a cleaner.

The electric work machine 1K includes a battery connector 2K, a controller 17K, a motor 4K, a switch 15K, an indicator 16K, a power supply housing 7K, a first housing 8K, a second housing 9K, and a sheath 10K. A battery 14K is connected to the battery connector 2K. The motor 4K is connected to the controller 17K. The switch 15K and the indicator 16K are connected to the controller 17K. The power supply housing 7K accommodates the battery connector 2K. The first housing 8K accommodates the motor 4K and the controller 17K without accommodating the switch 15K and the indicator 16K. The second housing 9K accommodates the switch 15K and the indicator 16K without accommodating the motor 4K and the controller 17K. The sheath 10K accommodates first electric wires 3K and second electric wires 5K. The sheath 10K has its upper end located inside the second housing 9K. The sheath 10K has its lower end located inside the first housing 8K. The second electric wires 5K extending from the sheath 10K are placed in the power supply housing 7K.

The electric work machine 1K includes a sheath cover 13K. The sheath cover 13K accommodates the sheath 10K and the second electric wires 5K extending outside the sheath 10K.

As shown in FIG. 21, the electric work machine 1K includes wheels 25K on the first housing 8K. The motor 4K rotates to generate a suction force at an inlet located in the lower surface of the first housing 8K.

In the present embodiment, the battery connector 2K, to which the battery 14K is connected, corresponds to the power supply device. The battery 14K is attachable to and detachable from the battery connector 2K. The motor 4K corresponds to the first electric component. The motor 4K drives the electric work machine 1K. The switch 15K and the indicator 16K correspond to the second electric component. The switch 15K is operable by the operator to activate the motor 4K. The controller 17K controls at least the motor 4K.

The electric work machine 1K includes multiple second electric wires 5K. At least one of the second electric wires 5K is a power line. The battery 14K supplies a drive current to the motor 4K through the power line.

The electric work machine 1K may include multiple second electric wires 5K. At least one of the second electric wires 5K is a signal line. An electric signal is transmitted through the signal line from the switch operated to activate the motor 4K to the controller 17K that controls the motor 4K.

### Other Embodiments

In the above embodiments, the electric work machine may be, for example, an impact driver, a driver drill, a screwdriver, or an angle impact driver used in screwing operations. The electric work machine may be at least one of a circular saw, a reciprocating saw, a grinder, a hammer drill, or a chain saw. The electric work machine may be an electric work machine without a tip tool, such as a blower, a duster, a cleaner, or a pressure washer.

In the above embodiments, the electric work machine may use utility power (alternating current power supply) in place of the power supply device.

### REFERENCE SIGNS LIST

1A electric work machine
1B electric work machine
1C electric work machine
1D electric work machine
1E electric work machine
1F electric work machine
1G electric work machine
1H electric work machine
1J electric work machine
1K electric work machine
2A power supply device
2B power supply device
2C power supply device
2D power supply device
2E power supply device
2F battery connector
2G battery connector
2H battery connector
2J battery connector
2K battery connector
3A first electric wire
3B first electric wire
3C first electric wire
3D first electric wire
3E first electric wire
3F first electric wire
3Fa power line
3Fb signal line
3G first electric wire
3Ga power line
3Gb signal line
3H first electric wire
3J first electric wire
3K first electric wire
4A first electric component
4B first electric component
4C first electric component
4D first electric component
4E first electric component
4F motor
4G motor
4H motor
4J motor
4K motor
5A second electric wire
5B second electric wire
5C second electric wire
5D second electric wire
5E second electric wire
5F second electric wire
5G second electric wire
5H second electric wire
5J second electric wire
5K second electric wire
6A second electric component
6B second electric component
6C second electric component
6D second electric component
6E second electric component
6F light
6G indicator
6H indicator
6J indicator
7A power supply housing
7B power supply housing
7C power supply housing
7D power supply housing
7E power supply housing
7F power supply housing
7G power supply housing
7H power supply housing
7J power supply housing
7K power supply housing
8A first housing
8B first housing
8C first housing
8D first housing
8E first housing
8F first housing
8G first housing
8H first housing
8J first housing
8K first housing
9A second housing
9B second housing
9C second housing
9D second housing
9E second housing
9F second housing
9G second housing
9H second housing
9J second housing
9K second housing
10A sheath
10B sheath
10C sheath
10D sheath
10E sheath
10F sheath
10G sheath
10H sheath
10J sheath
10K sheath
11C first connecting member
12C second connecting member
13D sheath cover
13F sheath cover
13G sheath cover
13H sheath cover
13J sheath cover
13K sheath cover
14F battery
14G battery
14H battery
14J battery
14K battery
15F switch
15K switch
16F indicator
16K indicator
17F controller
17G controller
17H controller
17J controller
17K controller
18F pipe
18G pipe
18H pipe
18J pipe
19F grip
20F grip
20G grip
20H grip
21F cleaning member
22F rotor shaft
23G grass cutting blade
23H grass cutting blade
24J blade
25K wheel
26 sensor board
30 connector
32 connector
32A housing
32B housing
32C engagement portion
32D tab
35 connector
35A housing
35B housing
35C engagement portion
35D tab
38 connector
38A housing
38B housing
38C male terminal

What is claimed is:

1. An electric work machine, comprising:
a power supply device;
a first electric component;
a second electric component;
a first electric wire connecting the power supply device and the first electric component;
a second electric wire connecting the power supply device and the second electric component;
a power supply housing accommodating the power supply device;
a first housing accommodating the first electric component without accommodating the second electric component;
a second housing accommodating the second electric component without accommodating the first electric component; and
a sheath accommodating the first electric wire and the second electric wire, the sheath having
a first end located inside the power supply housing, and
a second end located inside the first housing,
wherein the second electric wire extending from the sheath is placed in the second housing.

2. The electric work machine according to claim 1, wherein
the power supply device and the first electric component are arranged in a first direction, and
the second electric component is located between the power supply device and the first electric component in the first direction.

3. The electric work machine according to claim 1, wherein
the second electric wire extending from the sheath is folded and placed in the second housing.

4. The electric work machine according to claim 1, further comprising:
a sheath cover accommodating the sheath and the second electric wire extending outside the sheath.

5. The electric work machine according to claim 1, wherein
the sheath extends without through the second housing.

6. The electric work machine according to claim 1, wherein
the sheath extends through the second housing.

7. The electric work machine according to claim 1, further comprising:
a first connecting member connecting the power supply housing and the first housing.

8. The electric work machine according to claim 7, wherein
the first connecting member supports the sheath.

9. The electric work machine according to claim 1, further comprising:
a second connecting member connecting the first housing and the second housing.

10. The electric work machine according to claim 9, wherein
the second connecting member supports the second electric wire extending from the sheath.

11. The electric work machine according to claim 1, wherein
at least one of the first electric component or the second electric component is a motor.

12. The electric work machine according to claim 1, wherein
at least one of the first electric component or the second electric component is a light.

13. The electric work machine according to claim 1, wherein
at least one of the first electric component or the second electric component is a switch operable to activate the motor.

14. The electric work machine according to claim 1, wherein
at least one of the first electric component or the second electric component is a controller configured to control the motor.

15. The electric work machine according to claim 1, wherein
the power supply device is a battery connector to which a battery is connectable.

16. The electric work machine according to claim 15, wherein
the first electric wire is a power line through which a drive current flows from the battery to a motor.

17. The electric work machine according to claim 16, wherein
the second electric wire is a signal line through which an electric signal is transmitted from a switch operated to activate the motor to a controller configured to control the motor.

18. An electric work machine, comprising:
a power supply device;
a first electric component;
a second electric component;
a first electric wire connecting the first electric component and the second electric component;
a second electric wire connecting the power supply device and the second electric component;
a power supply housing accommodating the power supply device;
a first housing accommodating the first electric component without accommodating the second electric component;
a second housing accommodating the second electric component without accommodating the first electric component; and
a sheath accommodating the first electric wire and the second electric wire, the sheath having
a first end located inside the second housing, and
a second end located inside the first housing,
wherein the second electric wire extending from the sheath is placed in the power supply housing.

19. The electric work machine according to claim 18, wherein
the first electric component and the second electric component are arranged in a first direction, and
the power supply device is located between the first electric component and the second electric component in the first direction.

20. The electric work machine according to claim 18, wherein
the second electric wire extending from the sheath is folded and placed in the power supply housing.
